(19) United States
(12) Patent Application Publication
(10) Pub. No.: US 2012/0249077 A1
(43) Pub. Date: Oct. 4, 2012

(54) BATTERY SYSTEM FOR ELECTRICITY TRANSPORT VESSEL

(76) Inventor: Mordehay Carmel, Clearwater, FL (US)

(21) Appl. No.: 13/075,310

(22) Filed: Mar. 30, 2011

(51) Int. Cl. H02J 7/00; H01M 10/48; H01M 2/10

(52) U.S. Cl. 320/134; 429/96; 429/90; 320/128

(57) ABSTRACT

A battery or plurality of batteries adapted for to be installed in a transport vessel used as a method of transporting a large quantity of electricity. The battery system can be one rechargeable battery, or plurality placed rechargeable batteries installed for the life of the batteries. The vessel may include one battery, or many batteries, integrated into a ship, boat, or any other floating device, and, in case of more than one battery, are electrically connected to each other by wire or cable. There are one or more inlet/outlets that allow charging/discharging of the batteries. The batteries can be of any size, from the size of a shipping crate battery to larger batteries, the size of a cargo ship or larger. The electricity could be used for the same purposes as electricity transported through electric wires.

### RELATED FIELD

This invention relates to the transporting of electricity using one or more rechargeable batteries integrated with a vessel used as a means for transporting electricity to needed locations around the world, where there is no other means of transporting and delivering that electricity.

### BACKGROUND OF THE INVENTION

In pursuit of clean energy, the below described invention is presented as a solution which provides for clean energy. The idea is of creating big transport vessels like ships, boats, or any other floating device of any size up to super tankers, or larger, that would be integrated with rechargeable batteries, or be one large battery, to be charged at locations with a cheap electricity source, and to deliver the energy to other ports to be discharged into a local energy storage or into the local electric system. There is a need for a means of transporting electricity in a large quantity without using electric lines that could answer a large scale requirement, and supply power for a factory, city, small and large communities, an army unit and more. The invention's advantage is the ability to bring electricity from far away places to other locations where the electricity is needed, and delivering clean (green) electricity.

When the price of oil climbs beyond a certain price and the price and capacity to store electricity in batteries gets better and better, the present invention could work as sources of cheap electricity. Countries that have cheap hydro power, could export energy and become the next Saudi Arabia of electricity. The regulation for building nuclear facilities is very strict in some countries but not in other countries. By using this transportation method, it would be possible to build hydro power facilities or nuclear power facilities in distant countries or remote islands, making it economical to deliver energy to destinations where the energy is needed. Normally, transportation of electricity is done by electric wires connecting the source of electricity to recipients in other locations. This solution has earthbound limited distance and does not cross large bodies of water, or, if done so, at substantial expense. There are new developments of transporting electricity by wireless means, which are limited in distance. Up to now, batteries are used for supplying power to electronic devices, one vehicle or a house, or storing electricity for local use.

So far, energy sources that use vessels for transportation are oil, wood, coal, natural gas and propane gas.

### SUMMARY OF THE INVENTION

The present invention is a battery system integrated with an electricity transport vessel serving as means for transporting large quantities of electricity. The method of storing the electricity while transported is a rechargeable battery or a plurality of such rechargeable batteries in the size of a shipping crate or larger.

In accordance with an aspect of the invention, the batteries would be of high storage capacity, with the ability to be charged and discharged. The loaded vessel has the capacity of discharging the batteries partially, or in full. The batteries would be for the life of the batteries a part of the cargo of the vessel. The cargo of the vessel can comprise one or many batteries.

In accordance with an aspect of the invention, the batteries would be of high storage capacity, with the ability to be charged and discharged. The loaded vessel has the capacity of discharging the batteries partially, or in full. The batteries would be for the life of the batteries a part of the cargo of the vessel. The cargo of the vessel can comprise one or many batteries.

Such a battery system has one or several outlets where electricity could be charged into the battery(ies) and also discharged from the battery(ies) into an electricity storage or the land electric system, using one or several wires or cables.

Such a battery system has several cables or wires where electricity could be interconnected with other batteries.

The invention's advantage is the ability to bring electricity from far away places to other locations where the electricity is needed, and where there would be no other means of transporting electricity, or it would be more costly or unsafe. The invention further has the advantage that it does not rely on fixed electric lines or pipes and can be transported to any port or to another electricity transport vessel. Another advantage is the providing of energy where clean (green) energy is required. A large quantity of electricity where emergency requirements of electricity are needed can be provided, without relying on an intricate electric wire system.

### BRIEF DESCRIPTION OF THE DRAWINGS

The invention will be described in detail with reference to the drawings in which:

FIG. 1 is a conceptual sectional view of a vessel contemplated under the present invention showing the vessel having one large single battery integrated in the cargo space of a transport vessel or tanker ship;

FIG. 2 is a conceptual sectional view of a vessel contemplated under the present invention showing the vessel loaded with container sized batteries; and

FIG. 3 is a conceptual depiction, sectional view, of a battery the proximate size of a shipping container crate.

### DETAILED DESCRIPTION OF THE INVENTION

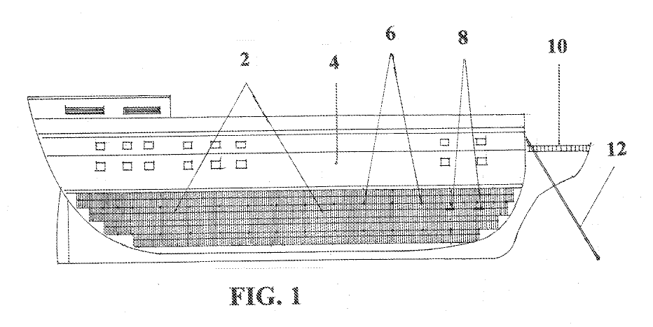

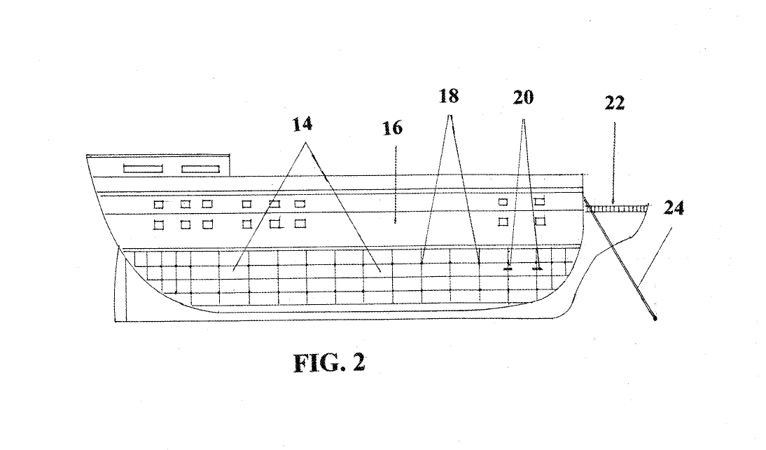

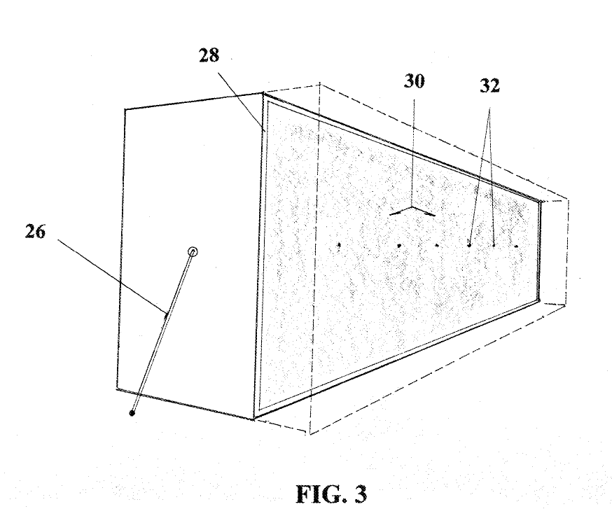

The invention is an electricity transport vessel for transporting a large quantity of electricity by means of a large sized battery (see FIG. 1), or a combination of many batteries see FIGS. 2 and 3). The control of the charging of the electricity to the batteries on the electricity transport vessel is done by a shore provider or the vessel's central control. The control of the discharging of the electricity from the electricity transport vessel is done by the electricity transport vessel or by the electricity receiver.

One economical method of extracting the power in the form of electricity or charging the batter(ies) on the vessel is to obtain the charging from a low cost source by purchasing the electricity from countries that offer relatively cheap electricity.

The loading and unloading of the electricity from the electricity transport vessel is done through electric cables which allow for the batteries simultaneous loading or unloading of the electricity.

As conceptually depicted in FIG. 1, which is a sectional view of a vessel 10 contemplated under the present invention showing the vessel as one battery 2, that is, the entire cargo area comprises one battery 2 which fills up the cargo space 4 of the vessel 10. Sensors 6 are preferably located at desired locations on the battery 2 for reporting the state of the battery equipment. Other sensors 8 are located throughout the cargo area 4 of the vessel 10 reporting the amount of electricity charged, and the state of the electrical storage in different parts of the battery 2. One or more cables 12 which connect the battery 2 to a charging terminal (not shown) when loading of electricity into the battery 2 and unloading the electricity from the battery 2 into a recipient terminal (not shown), or into the local electric system (not shown).

Another conceptual depiction of another embodiment of the present invention is shown in FIG. 2, which illustrates a sectional view of a vessel 22 showing the vessel 22 loaded with container sized batteries 14, which are shipping crate sized batteries.

Sensors 18 connected to a central control (not shown), are located throughout the batteries and reporting the state of the batteries' structure and the amount of electric charge stored in different parts of the batteries. Cables or wires 20 located throughout the cargo area 16, that allow the simultaneous charging of electricity and the simultaneous discharging of electricity to and from the batteries 14. One or more cables 24 are used to connect the batteries 14 to a charging terminal (not shown) when loading electricity into the batteries 14 and unloading the electricity from the batteries 14 into a recipient terminal (not shown), or into the local electric system (not shown).

The vessel 16,22 can be a ship, boat, barge or any other sea going cargo ship. In a preferred embodiment, the vessel's cargo area 4,16 is mostly filled with a large single battery 2 or a plurality of batteries 14. The batteries are contemplated to be high storage capacity batteries for storing electricity. The batteries can be made of lithium, nickel, manganese, potassium, zinc, sodium-sulfur or any other material which provides a high storage capacity of storing electricity. When a single battery is made the size of a vessel, then the battery could be a wet battery, dry battery, molten salt battery, or any other type of high storage capacity batteries.

FIG. 3 is a conceptual depiction, sectional view, of a battery the proximate size of a shipping container crate. These are the same batteries contemplated as installed in a vessel as conceptually depicted in FIG. 2. More specifically, the individual battery depicted in FIG. 3 and denoted by the numeral 30 is contemplated to be an approximate size equivalent to that of a cargo ship shipping container for ease of handling by port pier crane service. The size of a shipping crate is typically about 8′×8′×20′. One of the cables 26 is used to connect the battery 30 to an electric loading terminal or to an unloading recipient terminal, or the local electric system. The frame of the battery 30 is denoted by reference numeral 28. Sensors 32 are located throughout the battery 30, reporting the state of the battery equipment and the amount of electric charge stored in different parts of the battery.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A battery system configured for installation in a transport vessel for transporting and delivering needed electricity to remote sites across bodies of water, wherein said battery system comprises:
one battery or a plurality of batteries configured to be stored on or integrated with a transport vessel for a life of said one battery or said plurality of batteries.

2. The battery system according to claim 1, further comprising:
sensor means for monitoring a structural status and a charge status of said one or said plurality of batteries.

3. The battery system according to claim 1, further comprising:
one or more electrical cables for discharging electricity to a receiving terminal and for charging said one or said plurality of batteries wherein said electricity is stored in said one or said plurality batteries for future discharging.

4. The battery system according to claim 1, wherein said plurality of batteries comprises individual batteries sized to proximate a size of a shipping container crate used on cargo shipping vessels, said individual batteries being in electrical communication with each other.

5. The battery system according to claim 1, wherein said one battery is sized to be integrated within a cargo area of said transport vessel.

6. The battery system according to claim 1, wherein said plurality of batteries are made from a high storage capacity battery material comprising lithium, nickel, manganese, potassium, zinc, sodium-sulfur.

7. The battery system according to claim 1, wherein said one battery is a battery comprising a wet battery, a dry battery, and a molten salt battery.

8. An electricity transport vessel used as a method of transporting electricity to and from locations separated by a body of water, the vessel comprising, in combination therewith:
one battery or a plurality of batteries, said one battery and said plurality of batteries being stored on said vessel for the life of the one battery and said plurality of batteries;
sensor means for monitoring a structural status and a charge status of said one battery or said plurality of batteries; and
one or more electrical cables for discharging electricity to a receiving terminal and for charging said one battery or a plurality of batteries wherein said electricity is stored in said one battery or a plurality of batteries for future discharging.

9. The vessel according to claim 8, wherein said one battery in a cargo area of said vessel comprises is an integrated battery with said cargo area.

10. The vessel according to claim 8, wherein a cargo area of said vessel comprises said plurality of batteries.

11. The vessel according to claim 10, wherein said plurality of batteries are electrically connected together.

12. The vessel according to claim 8, wherein said plurality of batteries are made from a high storage capacity battery material comprising lithium, nickel, manganese, potassium, zinc, sodium-sulfur.

13. The vessel according to claim 8, wherein said one battery is a battery comprising a wet battery, a dry battery, and a molten salt battery.
